(19) United States
(12) Patent Application Publication
(10) Pub. No.: US 2026/0196827 A1
(43) Pub. Date: Jul. 9, 2026

(54) CONTROL APPARATUS

(71) Applicant: DENSO ELECTRONICS CORPORATION, Anjo-city (JP)

(72) Inventor: Tomokatsu FUSEYA, Anjo-city (JP)

(21) Appl. No.: 19/439,543

(22) Filed: Jan. 5, 2026

(30) Foreign Application Priority Data
Jan. 8, 2025 (JP) 2025-002938

(51) Int. Cl. H02H 9/02; H02P 7/03

(52) U.S. Cl. CPC H02H 9/02; H02P 7/04

(57) ABSTRACT

A control apparatus includes an H-bridge circuit, a wire connected in series with an electrical load, first and second control units, first and second rise amount calculation units, and a wire temperature calculation unit. The H-bridge circuit includes four switches arranged between high and low potential nodes, with first and second common connection terminals. The first control unit activates the first and fourth switches, passing a first current through the wire and load; the second control unit activates the second and third switches, passing a second current. The first and second rise amount calculation units determine the wire's temperature rise based on the respective currents during each operation. The wire temperature calculation unit calculates the wire's temperature by integrating the temperature rise amounts from both operations.

### CROSS REFERENCE TO RELATED APPLICATION

This application is based on Japanese Patent Application No. 2025-002938 filed on Jan. 8, 2025, the disclosure of which is incorporated herein by reference.

### TECHNICAL FIELD

The present disclosure relates to a control apparatus.

### BACKGROUND

An overcurrent protection circuit may include a semiconductor switch and a control apparatus. The semiconductor switch is disposed between a positive electrode and a negative electrode of a power supply in the overcurrent protection circuit. An input terminal of the semiconductor switch is connected to the positive electrode. An output terminal of the semiconductor switch is connected to an electrical load. The electrical load is disposed between the output terminal of the semiconductor switch and the negative electrode.

### SUMMARY

According to an aspect of the present disclosure, a control apparatus may have an H-bridge circuit, a wire, and a control circuit. The H-bridge circuit may include: a high potential node having a predetermined potential; a low potential node having a potential lower than the high potential node; a first switch located between the high potential node and the low potential node; a second switch located between the first switch and the low potential node; a third switch located between the high potential node and the low potential node; and a fourth switch located between the third switch and the low potential node. The wire may be connected to an electrical load in series between a first common connection terminal and a second common connection terminal. The first common connection terminal may be a terminal to which the first switch and the second switch are commonly connected, and the second common connection terminal may be a terminal to which the third switch and the fourth switch are commonly connected. The control circuit may execute a first operation and a second operation. The first operation is an operation in which the first switch and the fourth switch are turned on to pass a first current from the high potential node to the low potential node through the first switch, the electrical load and the fourth switch. The second operation is an operation in which the second switch and the third switch are turned on to pass a second current from the high potential node to the low potential node through the third switch, the electrical load, and the second switch. The control circuit may calculate a first temperature rise amount of the wire, the first temperature rise amount being based on the first current and corresponding to a temperature rise of the wire in conjunction with the first operation. In addition, the control circuit may calculate a second temperature rise amount of the wire, the second temperature rise amount being based on the second current and corresponding to a temperature rise of the wire in conjunction with the second operation. Moreover, the control circuit may calculate a temperature of the wire based on the first temperature rise amount and the second temperature rise amount.

### BRIEF DESCRIPTION OF DRAWINGS

FIG. 1 is a block diagram showing an electrical circuit configuration of a motor control apparatus for a vehicle according to a first embodiment of the present disclosure.

FIG. 2 is a flowchart showing details of the motor control processing executed by a control circuit in the first embodiment of FIG. 1.

FIG. 3 is an electrical circuit diagram showing an electrical circuit configuration of an H-bridge circuit in a motor control apparatus for a vehicle according to a second embodiment of the present disclosure.

FIG. 4 is an electrical circuit diagram showing the connection relationships among the H-bridge circuit, a current detector, a temperature detector, and a control circuit in the motor control apparatus for a vehicle according to the second embodiment of FIG. 3.

### DETAILED DESCRIPTION

When a semiconductor switch is turned on in an overcurrent protection circuit, a load current may flow from a positive electrode of a power supply, through the semiconductor switch and the electrical load, to a negative electrode of the power supply. As a result, power may be supplied from the power supply to the electrical load. A control apparatus may determine whether an overcurrent is flowing through a wire connecting the semiconductor switch and the electrical load, based on the load current flowing through the semiconductor switch. When the control apparatus determines that an overcurrent is flowing through the wire, the control apparatus may turn off the semiconductor switch. As a result, overcurrent protection that suppresses the flow of overcurrent through the wire and protects the wire from overcurrent may be executed for each semiconductor switch.

The inventor in the present application, with reference to the above overcurrent protection circuit, considered an execution of overcurrent protection for wires connected to an electrical load in an H-bridge circuit that includes a first semiconductor switch, a second semiconductor switch, a third semiconductor switch, and a fourth semiconductor switch. The first semiconductor switch is disposed between the positive electrode of the power supply and the second semiconductor switch. The second semiconductor switch is disposed between the first semiconductor switch and the negative electrode. The third semiconductor switch is disposed between the positive electrode of the power supply and the fourth semiconductor switch. The fourth semiconductor switch is disposed between the third semiconductor switch and the negative electrode.

Hereinafter, the terminal to which both the first semiconductor switch and the second semiconductor switch are commonly connected is referred to as a first common connection terminal, and the terminal to which both the third semiconductor switch and the fourth semiconductor switch are commonly connected is referred to as a second common connection terminal. A direct current motor is connected between the first common connection terminal and the second common connection terminal via wires. When the control circuit turns off the second semiconductor switch and the third semiconductor switch, and turns on the first semiconductor switch and the fourth semiconductor switch, a first current flows from the positive electrode of the power supply to the negative electrode via the first semiconductor switch, the direct current motor, and the fourth semiconductor switch.

As a result, the direct current motor rotates its output shaft in the forward direction based on the first current. On the other hand, when the control circuit turns off the first semiconductor switch and the fourth semiconductor switch, and turns on the third semiconductor switch and the second semiconductor switch, a second current flows from the positive electrode of the power supply to the negative electrode via the third semiconductor switch, the direct current motor, and the second semiconductor switch. As a result, the direct current motor rotates its output shaft in the reverse direction based on the second current.

The control circuit calculates the temperature of the wire based on the first current when the direct current motor is rotating in the forward direction. The control circuit determines whether an overcurrent is flowing through the wire by judging whether the temperature of the wire is equal to or higher than a threshold value. When the control circuit determines that an overcurrent is flowing through the wire during the forward rotation of the direct current motor, it turns off the first semiconductor switch, the second semiconductor switch, the third semiconductor switch, and the fourth semiconductor switch. As a result, it is possible to suppress an overcurrent from flowing through the wire during the forward rotation of the direct current motor.

The control circuit calculates the temperature of the wire based on the second current when the direct current motor is rotating in the reverse direction. The control circuit determines whether an overcurrent is flowing through the wire by determining whether the temperature of the wire is equal to or higher than a threshold value. When the control circuit determines that an overcurrent is flowing through the wire during the reverse rotation of the direct current motor, the control circuit turns off the first semiconductor switch, the second semiconductor switch, the third semiconductor switch, and the fourth semiconductor switch. As a result, it is possible to suppress an overcurrent from flowing through the wire during the reverse rotation of the direct current motor.

During the forward rotation of the direct current motor, the wire generates heat based on the first current. During the reverse rotation of the direct current motor, the wire generates heat based on the second current. Therefore, for example, the control circuit independently calculates the temperature of the wire during the forward rotation and the reverse rotation of the direct current motor. As a result, the control circuit calculates the temperature of the wire without summing the amount of heat generated from the wire during the forward rotation of the direct current motor and the amount of heat generated during the reverse rotation. As a result, a temperature lower than the actual temperature of the wire is calculated by the control circuit. Therefore, the control circuit is unable to correctly calculate the temperature of the wire.

According to an aspect of the present disclosure, a control apparatus includes an H-bridge circuit, a wire, a first control unit, a second control unit, a first rise amount calculation unit, a second rise amount calculation unit, and a wire temperature calculation unit. The H-bridge circuit includes: a high potential node having a predetermined potential; a low potential node having a potential lower than the high potential node; a first switch located between the high potential node and the low potential node; a second switch located between the first switch and the low potential node; a third switch located between the high potential node and the low potential node; and a fourth switch located between the third switch and the low potential node. The wire is connected to an electrical load in series between a first common connection terminal and a second common connection terminal. The first common connection terminal is a terminal to which the first switch and the second switch are commonly connected, and the second common connection terminal is a terminal to which the third switch and the fourth switch are commonly connected. The first control unit turns on the first switch and the fourth switch to pass a first current from the high potential node to the low potential node through the first switch, the electrical load and the fourth switch. The second control unit turns on the second switch and the third switch to pass a second current from the high potential node to the low potential node through the third switch, the electrical load, and the second switch. The first rise amount calculation unit calculates a first temperature rise amount of the wire, the first temperature rise amount being based on the first current and corresponding to a temperature rise of the wire in conjunction with the first operation. In addition, the second rise amount calculation unit calculates a second temperature rise amount of the wire, the second temperature rise amount being based on the second current and corresponding to a temperature rise of the wire in conjunction with the second operation. Moreover, the wire temperature calculation unit calculates a temperature of the wire based on the first temperature rise amount and the second temperature rise amount.

Therefore, according to the above aspect of the present disclosure, it is possible to accurately calculate the temperature of the wire.

### First Embodiment

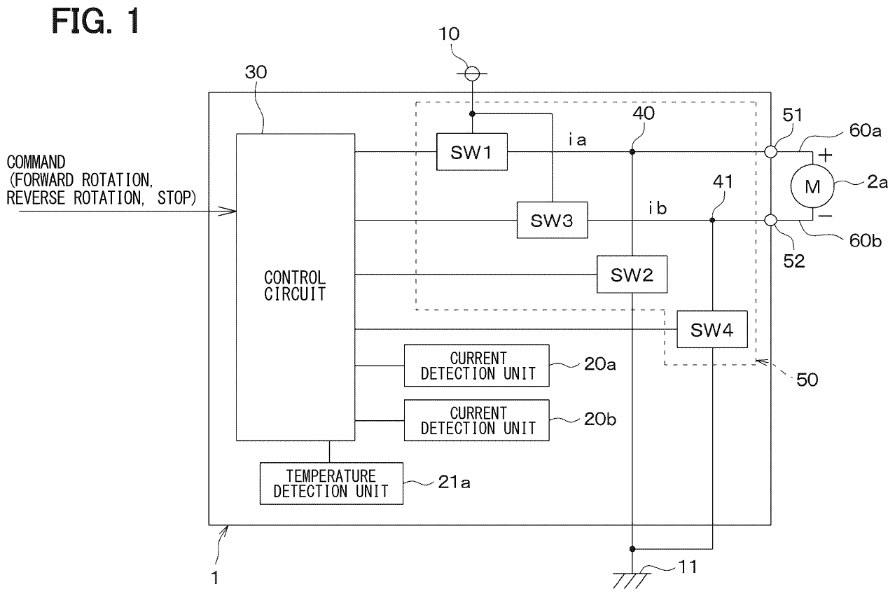

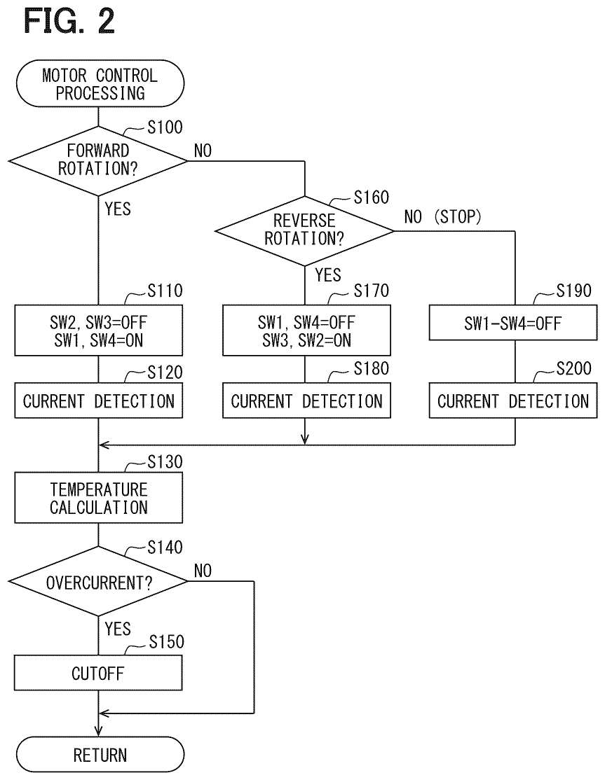

FIGS. 1 and 2 illustrate a first embodiment of a vehicle motor control apparatus 1 to which the control apparatus of the present disclosure is applied. As shown in FIG. 1, the vehicle motor control apparatus 1 of the present embodiment includes semiconductor switches SW1, SW2, SW3, and SW4, current detection units 20a and 20b, a temperature detection unit 21a, and a control circuit 30. The semiconductor switch SW1 is a first switch disposed between a positive electrode 10 of the DC power supply and the semiconductor switch SW2. The positive electrode 10 is a high potential portion of the DC power supply having a predetermined positive potential.

A negative electrode 11 is a low potential portion of the DC power supply having a lower potential than the positive electrode 10. The semiconductor switch SW2 is a second switch disposed between the semiconductor switch SW1 and the negative electrode 11. Furthermore, the semiconductor switch SW3 is a third switch disposed between the positive electrode 10 and the semiconductor switch SW4. The semiconductor switch SW4 is a fourth switch disposed between the semiconductor switch SW3 and the negative electrode 11.

The input terminal of the semiconductor switch SW1 is connected to the positive electrode 10. The output terminal of the semiconductor switch SW1 is connected to the input terminal of the semiconductor switch SW2. The output terminal of the semiconductor switch SW2 is connected to the negative electrode 11. The input terminal of the semiconductor switch SW3 is connected to the positive electrode 10. The output terminal of the semiconductor switch SW3 is connected to the input terminal of the semiconductor switch SW4. The output terminal of the semiconductor switch SW4 is connected to the negative electrode 11.

The control terminals of the semiconductor switches SW1, SW2, SW3, and SW4 are each connected to the control circuit 30. The semiconductor switches SW1, SW2, SW3, and SW4 constitute an H-bridge circuit 50 for controlling a DC motor 2a, as will be described later. As the semiconductor switches SW1, SW2, SW3, and SW4 in the present embodiment, various semiconductor devices such as metal-oxide-semiconductor field-effect transistors, insulated-gate bipolar transistors, and bipolar transistors may be used, for example.

For convenience of explanation, the terminal to which the semiconductor switches SW1 and SW2 are commonly connected will hereinafter be referred to as a common connection terminal 40, and the terminal to which the semiconductor switches SW3 and SW4 are commonly connected will be referred to as a common connection terminal 41. The common connection terminals 40 and 41 are connected via an input/output terminal 51, a wire 60a, the DC motor 2a, a wire 60b, and an input/output terminal 52. The input/output terminals 51 and 52 are input/output terminals provided in the motor control apparatus 1 for a vehicle, respectively. The input/output terminal 51 is disposed between the common connection terminal 40 (i.e., the first common connection terminal) and the positive electrode of the DC motor 2a. The input/output terminal 52 is disposed between the common connection terminal 41 (i.e., the second common connection terminal) and the negative electrode of the DC motor 2a. The wire 60a is a wire that connects the input/output terminal 51 and the positive electrode of the DC motor 2a. In the present disclosure, the wire may also be referred to as an electric wire.

Further, the wire 60b is a wire that connects the negative electrode of the DC motor 2a and the input/output terminal 52. As the wires 60a and 60b, for example, automotive wires such as AVSS or CIVUS can be used. The DC motor 2a is an electrical load that is supplied with power from a DC power supply and rotates its output shaft. The DC motor 2a can be used, for example, as a door lock motor for driving an automobile door lock mechanism, a wiper motor for driving an automobile wiper, or a washer motor for spraying washer fluid.

The current detection unit 20a is a detection element for detecting a first current, which is a current ia flowing through the wires 60a and 60b between the positive electrode 10 and the negative electrode 11 when the semiconductor switches SW1 and SW4 are turned on, as will be described later. As the current detection unit 20a of the present embodiment, for example, a detection element (such as a differential amplifier circuit) that amplifies and outputs the terminal voltage, which is the voltage between the input and output terminals of the semiconductor switch SW1, can be used. The terminal voltage is used to calculate the current flowing between the input and output terminals of the semiconductor switch SW1 as the current ia flowing through the wires 60a and 60b.

The current detection unit 20b is a detection element for detecting a second current, which is a current ib flowing through the wires 60a and 60b between the positive electrode 10 and the negative electrode 11 when the semiconductor switches SW2 and SW3 are turned on, as will be described later. As the current detection unit 20b of the present embodiment, for example, a detection element (such as a differential amplifier circuit) that amplifies and outputs the terminal voltage, which is the voltage between the input and output terminals of the semiconductor switch SW3, can be used.

The terminal voltage is used to calculate the current flowing between the input and output terminals of the semiconductor switch SW3 as the current ib flowing through the wires 60a and 60b. The temperature detection unit 21a is a temperature detection unit for detecting the ambient temperature of the wires 60a and 60b. As the temperature detection unit 21a of the present embodiment, various temperature detection elements such as a temperature detection diode or a thermistor can be used.

The control circuit 30 is a microcomputer equipped with a CPU, RAM, ROM, non-volatile rewritable memory, an analog-to-digital converter, and the like. Further, the control circuit 30 executes a computer program recorded in a ROM or non-volatile rewritable memory, which is a non-transitory tangible recording medium, while power is supplied from the power supply device. Furthermore, the control circuit 30 executes various control processes, such as the motor control process shown in FIG. 2, in accordance with the execution of the computer program.

As will be described later, the motor control process controls the DC motor 2a and, based on the currents ia and ib, performs wire protection to prevent overcurrent from flowing through the wires 60a and 60b. FIG. 2 is a flowchart showing the details of the motor control process in the control circuit 30. Various constants for calculating the temperatures of the wires 60a and 60b are recorded in the ROM and non-volatile rewritable memory, along with the computer program. The analog-to-digital converter converts the output voltages of the current detection units 20a and 20b, as well as the output voltage of the temperature detection unit 21a, into digital data, respectively.

Next, the operation of the vehicle motor control apparatus 1 according to the present embodiment will be described with reference to FIGS. 1 and 2.

First, the temperature detection unit 21a outputs to the control circuit 30 an output voltage indicating the ambient temperature of the wires 60a and 60b. The current detection unit 20a outputs to the control circuit 30 an output voltage indicating the voltage between the terminals of the semiconductor switch SW1. The current detection unit 20b outputs to the control circuit 30 an output voltage indicating the voltage between the terminals of the semiconductor switch SW2. The analog-to-digital converter of the control circuit 30 repeatedly converts the respective output voltages of the current detection unit 20a, the current detection unit 20b, and the temperature detection unit 21a into digital data.

Hereinafter, for convenience of explanation, the digital data indicating the output voltage of the temperature detection unit 21a will be referred to as temperature data. In addition, the digital data indicating the output voltage of the current detection unit 20a will be referred to as forward rotation voltage data. The digital data indicating the output voltage of the current detection unit 20b will be referred to as reverse rotation voltage data. The temperature data is digital data indicating the ambient temperature around the wires 60a and 60b. The forward rotation voltage data is digital data indicating the voltage between the terminals of the semiconductor switch SW1 during forward rotation of the DC motor 2a. The reverse rotation voltage data is digital data indicating the voltage between the terminals of the semiconductor switch SW3 during reverse rotation of the DC motor 2a.

Further, the control circuit 30 starts executing the motor control process according to the flowchart in FIG. 2. The motor control process is repeatedly executed by the control circuit 30. First, in S100, the control circuit 30 determines whether a forward rotation command to rotate the DC motor 2a forward has been received from the electronic control unit. At this time, the control circuit 30 determines YES when the control circuit 30 determines that the forward rotation command has been received from the electronic control unit.

In response to this, in S110, the control circuit 30, functioning as the first control unit, keeps the semiconductor switches SW1 and SW4 continuously turned on while keeping the semiconductor switches SW2 and SW3 turned off. As a result, current ia flows from the positive electrode 10 of the DC power supply through the semiconductor switch SW1, the input/output terminal 51, the wire 60a, the DC motor 2a, the wire 60b, the input/output terminal 52, and the semiconductor switch SW4 to the negative electrode 11. Accordingly, the DC motor 2a rotates its output shaft in the forward direction by the electric power supplied from the DC power supply.

At this time, the wires 60a and 60b generate heat based on the current ia. As a result, the temperatures of the wires 60a and 60b rise above their initial temperature TO. Next, in S120, the control circuit 30 calculates the current ia [A] by dividing the terminal voltage of the semiconductor switch SW1, based on the forward rotation voltage data, by the ON resistance of the semiconductor switch SW1. The current ia is used as a first current that flows through the respective conductors of the wires 60a and 60b during the forward rotation of the DC motor 2a. The ON resistance is the resistance value between the input and output terminals of the semiconductor switch SW1 when the semiconductor switch SW1 is in the ON state. The ON resistance is previously recorded in a ROM or non-volatile rewritable memory.

Next, in S130, the control circuit 30, functioning as a wire temperature calculation unit, calculates the temperature T1 of the wires 60a and 60b based on the current ia calculated in S120 and the temperature data. The temperature T1 is the temperature calculated in the temperature calculation process of S130 executed for the first time after the start of execution of the motor control processing. Hereinafter, the temperature of the wires 60a and 60b is also referred to as the wire temperature. Specifically, the control circuit 30, functioning as a first temperature rise calculation unit, calculates the temperature rise ΔTa by substituting the current ia, constants r, R, C, and time t into Equation 1.

$$Δ Ta = {i}_{a}^{2} \cdot r \cdot R ( 1 - {e}^{- \frac{1}{c \cdot R} \cdot t} ) \qquad [ Equation 1 ]$$

Equation 1 is a mathematical expression for calculating the temperature rise ΔTa of the wires 60a and 60b when the semiconductor switches SW1 and SW4 are turned on. The temperature rise ΔTa is the increase in the wire temperature (i.e., the first temperature rise) that occurs during the period in which the semiconductor switches SW1 and SW4 remain continuously on. The constant r is the resistance value [Ω] of the conductors of wires 60a and 60b. The constant R is the thermal resistance [° C./W] of the respective conductors of wires 60a and 60b.

In addition, the constant C is the heat capacity of the respective conductors of the wires 60a and 60b. The units for heat capacity are [J/° C.] or [W·sec/° C.]. The time T is the period during which the semiconductor switches SW1 and SW4 remain continuously on while the semiconductor switches SW2 and SW3 are off. Furthermore, the constants r, R, and C are previously recorded in a ROM or non-volatile rewritable memory. In addition, in order to accommodate characteristic changes due to temperature, a value obtained by correcting the value of constant r recorded in the ROM or non-volatile rewritable memory based on ambient temperature or the like may be used as the constant r.

In addition, in the above S130, the control circuit 30 calculates the ambient temperature of the wires 60a and 60b based on the temperature data, and sets this ambient temperature of the wires 60a and 60b as the initial temperature TO of wires 60a and 60b. Furthermore, as shown in Equation 2, the control circuit 30 calculates the temperature T1 of wires 60a and 60b by adding the temperature rise ΔTa to the initial temperature TO of wires 60a and 60b.

$${T}_{1} = {T}_{0} + Δ Ta \qquad [ Equation 2 ]$$

In this way, the control circuit 30 calculates the temperature T1 of the wires 60a and 60b using Equation 1 and Equation 2. At this time, if an overcurrent flows through the wires 60a and 60b, the temperature T1 of the wires 60a and 60b becomes abnormally high. Therefore, in S140, the control circuit 30, functioning as a first current determination unit, determines whether an overcurrent is flowing through the wires 60a and 60b by judging whether the temperature T1 of the wires 60a and 60b is equal to or higher than a threshold value.

At this time, in the subsequent S140, the control circuit 30 determines NO, indicating that no overcurrent is flowing through the wires 60a and 60b, when the temperature T1 of the wires 60a and 60b is below the threshold value. Thereafter, when the control circuit 30 receives a reverse rotation command for the DC motor 2a from the electronic control unit, the control circuit 30 determines NO in S100 and YES in S160. In conjunction with this, in S170, the control circuit 30, functioning as a second control unit, turns off the semiconductor switches SW1 and SW4, and continues to turn on the semiconductor switches SW2 and SW3.

As a result, the current ib flows from the positive electrode 10 of the DC power supply through the semiconductor switch SW3, the input/output terminal 52, the wire 60b, the DC motor 2a, the wire 60a, the input/output terminal 51, and the semiconductor switch SW2 to the negative electrode 11. Accordingly, the DC motor 2a reverses its output shaft by means of the electric power supplied from the DC power supply. At this time, the wires 60a and 60b generate heat based on the current ib. Accordingly, the temperatures of the wires 60a and 60b increase beyond their previous temperature T1.

Next, in S180, the control circuit 30 calculates the current ib [A] by dividing the terminal voltage of the semiconductor switch SW3 by the ON-resistance of the semiconductor switch SW3, based on the reverse rotation voltage data. Here, the current ib is used as a second current flowing through the respective conductors of the wires 60a and 60b when the DC motor 2a is rotating in the reverse direction. The ON-resistance is the resistance value between the input terminal and the output terminal of the semiconductor switch SW3 when the semiconductor switch SW3 is in the ON state. The ON-resistance is previously recorded in a ROM or non-volatile rewritable memory.

Next, in S130, the control circuit 30 calculates the temperature T2 of the wires 60a and 60b based on the current ib calculated in the above S180. The temperature T2 is the temperature calculated in the temperature calculation process of S130, which is executed for the second time after the start of the execution of the motor control process. Specifically, as the second rise amount calculation unit, the control circuit 30 substitutes the current ib, constants r, R, C, and time T into Equation 3 to calculate the temperature rise amount ΔTb (i.e., the second temperature rise amount).

$$Δ Tb = {i}_{b}^{2} \cdot r \cdot R ( 1 - {e}^{- \frac{1}{c \cdot R} \cdot t} ) \qquad [ Equation 3 ]$$

Equation 3 is a mathematical expression for calculating the temperature rise amount ΔTb of the wires 60a and 60b when the semiconductor switches SW3 and SW2 are turned on. The temperature rise amount ΔTb is the increase in wire temperature that occurs during the period in which the semiconductor switches SW3 and SW2 remain continuously turned on. The time T is the period during which the semiconductor switches SW3 and SW2 remain continuously turned on. In addition, in the above S130, as shown by Equation 4, the control circuit 30 calculates the temperature T2 of the wires 60a and 60b by adding the temperature T1 of the wires 60a and 60b and the temperature rise amount ΔTb.

$${T}_{2} = {T}_{1} + Δ Tb \qquad [ Equation 4 ]$$

As described above, the control circuit 30 calculates the temperature T2 of the wires 60a and 60b using the Equation 3 and Equation 4. Accordingly, in S140, the control circuit 30 determines NO, meaning that no overcurrent is flowing through the wires 60a and 60b, if the temperature T2 of the wires 60a and 60b is below the threshold value.

Thereafter, when the control circuit 30 receives a stop command for stopping the DC motor 2a from the electronic control unit, it determines NO in S100, and also determines NO in S160. Accordingly, in S190, the control circuit 30, functioning as the third control unit, continues to keep the semiconductor switches SW1, SW2, SW3, and SW4 turned off, respectively. Accordingly, the flow of current between the positive electrode 10 and the negative electrode 11 of the DC power supply through the DC motor 2a and the wires 60a and 60b is stopped. As a result, since the supply of power from the DC power supply to the DC motor 2a is stopped, the output shaft is brought to a halt.

At this time, the wires 60a and 60b dissipate heat to their surroundings. Accordingly, the temperatures of the wires 60a and 60b decrease from the temperature T2 and approach the ambient temperature. Therefore, in the next S200, the control circuit 30 calculates the current i flowing through wires 60a and 60b in order to determine the temperatures of wires 60a and 60b. For example, the control circuit 30 calculates the current i, as in S120 described above, by dividing the voltage across the terminals of the semiconductor switch SW1 by the on-resistance of the semiconductor switch SW1. At this time, the output voltages of the current detection units 20a and 20b each become zero [V]. Therefore, the current i flowing through the respective conductors of wires 60a and 60b becomes zero [A].

Next, in S130, the control circuit 30 calculates the temperatures T3 of the respective conductors of the wires 60a and 60b, taking into account heat dissipation from the conductors of wires 60a and 60b to their surroundings, based on the temperature data. The temperature T3 is the temperature calculated in the temperature calculation process of S130, which was executed for the third time after the start of execution of the motor control processing. Specifically, the control circuit 30 calculates the ambient temperatures Ts of the wires 60a and 60b based on the temperature data. In addition, the control circuit 30 substitutes the ambient temperature Ts, current i, constant r, constant R, constant C, and time T into Equation 5 to calculate the temperatures T3 of the wires 60a and 60b.

The current i, constant r, constant R, and constant C are as described above. The time T is the period during which each of the semiconductor switches SW1, SW2, SW3, and SW4 has been continuously turned off. As described above, the current i is zero. Therefore, the temperatures T3 of the wires 60a and 60b become equal to the ambient temperature Ts of the wires 60a and 60b.

$${T}_{3} = T s + {i}^{2} \cdot r \cdot R \cdot {e}^{- \frac{1}{c \cdot R} \cdot t} \qquad [ Equation 5 ]$$

Next, in S140, when the temperatures T3 of the wires 60a and 60b are below the threshold value, the control circuit 30 determines NO, determining that no overcurrent is flowing through the wires 60a and 60b. Thereafter, as long as the temperatures of the wires 60a and 60b are determined to be below the threshold (NO) in S140, the control circuit 30 executes one of the following: the forward rotation process in S110, the reverse rotation process in S170, or the stop process in S190.

Thereafter, in the n-th execution of S100, when the control circuit 30 receives a stop command from the electronic control unit, it determines NO, and also determines NO in S160. n is an integer equal to or greater than 4. Accordingly, in the next S170, the control circuit 30 turns off each of the semiconductor switches SW1, SW2, SW3, and SW4. Therefore, the flow of current to the DC motor 2a and wires 60a and 60b between the positive electrode 10 and negative electrode 11 of the DC power supply is stopped.

As a result, the DC motor 2a stops its output shaft. At this time, the wires 60a and 60b dissipate heat to their surroundings. Therefore, the temperatures of the wires 60a and 60b decrease from their previous temperature Tn−1 and approach the ambient temperature Ts. Here, the temperature Tn−1 is the temperature of the wires 60a and 60b calculated by the control circuit 30 in S130 executed for the (n−1)th time.

Next, in S200, the control circuit 30, in the same manner as described above, calculates zero [A] as the current i flowing through the wires 60a and 60b. Next, in S130, the control circuit 30 calculates the ambient temperature Ts of the wires 60a and 60b based on temperature data, and then substitutes this ambient temperature Ts, current i, constants r, R, and C, and time T into Equation 6 to calculate the temperature Tn of the wires 60a and 60b.

The temperature Tn of the wires 60a and 60b becomes equal to the ambient temperature Ts of the wires 60a and 60b. As a result, it is possible to calculate the temperature Tn of the wires 60a and 60b, taking into account the heat dissipation from the respective conductors of the wires 60a and 60b to their surroundings.

$${T}_{n} = T s + {i}^{2} \cdot r \cdot R \cdot {e}^{- \frac{1}{c \cdot R} \cdot t} \qquad [ Equation 6 ]$$

Accordingly, in S140, when the temperature Tn of the wires 60a and 60b is below the threshold value, the control circuit 30 determines NO, determining that no overcurrent is flowing through the wires 60a and 60b.

Next, in the (n+1)th execution of S100, when the control circuit 30 receives a forward rotation command from the electronic control unit, it determines YES. Accordingly, in S110, the control circuit 30 keeps the semiconductor switches SW1 and SW4 continuously turned on while the semiconductor switches SW2 and SW3 remain turned off. As a result, the current ia flows from the positive electrode 10 of the DC power supply, through the semiconductor switch SW1, the input/output terminal 51, the wire 60a, the DC motor 2a, the wire 60b, and the input/output terminal 52, to the negative electrode 11. Accordingly, the DC motor 2a rotates its output shaft in the forward direction by the electric power supplied from the DC power supply. As a result, the wires 60a and 60b generate heat based on the current ia. At this time, the temperatures of the wires 60a and 60b become higher than the temperature Tn of the wires 60a and 60b.

Next, in S120, the control circuit 30 calculates the current ia based on the forward rotation voltage data. Next, in S130, the control circuit 30 calculates the temperature Tn+1 of the wires 60a and 60b based on the current ia calculated in S120. The temperature Tn+1 is the temperature calculated in the temperature calculation process of S130, which is executed for the (n+1)th time after the start of motor control processing. Specifically, the control circuit 30 calculates the temperature rise ΔTn+1 by substituting the current ia, constants r, R, and C, and the time T into Equation 7.

$$Δ {T}_{n + 1} = {i}_{a}^{2} \cdot r \cdot R ( 1 - {e}^{- \frac{1}{c \cdot R} \cdot t} ) \qquad [ Equation 7 ]$$

Equation 7 is a mathematical expression for calculating the temperature rise ΔTn+1 of the wires 60a and 60b when the semiconductor switches SW1 and SW4 are turned on. The temperature rise ΔTn+1 is the increase in the wire temperature that occurs during the period in which the semiconductor switches SW1 and SW4 remain continuously on. The time T is the period during which the semiconductor switches SW1 and SW4 remain continuously on in S110. In addition, in the above S130, as shown in Equation 8, the control circuit 30 calculates the temperature Tn+1 of the wires 60a and 60b by adding the temperature rise ΔTn+1 to the temperature Tn of the wires 60a and 60b.

$${T}_{n + 1} = {T}_{n} + Δ {T}_{n + 1} \qquad [ Equation 8 ]$$

Next, in S140, when the temperature Tn+1 of the wires 60a and 60b is below the threshold, the control circuit 30 determines that no overcurrent is flowing through the wires 60a and 60b and makes a NO determination. Thereafter, when the control circuit 30 receives a reverse command from the electronic control unit, it makes a NO determination in the (n+2)th execution of S100, and a YES determination in S160.

Accordingly, in S170, the control circuit 30 turns off semiconductor switches SW1 and SW4, and turns on semiconductor switches SW2 and SW3. As a result, current ib flows from the positive electrode 10 through semiconductor switch SW3, input/output terminal 52, wire 60b, DC motor 2a, wire 60a, input/output terminal 51, and semiconductor switch SW2 to the negative electrode 11. Accordingly, the DC motor 2a reverses its output shaft by the power supplied from the DC power supply.

Next, in S180, the control circuit 30 calculates the current ib based on the reverse rotation voltage data. Next, in S130, the control circuit 30 calculates the temperature Tn+2 of wires 60a and 60b based on the current ib. This temperature Tn+2 is the temperature calculated by the temperature calculation process of S130, executed for the (n+2)th time after the start of the motor control processing. Specifically, the control circuit 30 calculates the temperature rise ΔTn+2 by substituting the current ib, constant r, constant R, constant C, and time T into Equation 9.

$$Δ {T}_{n + 2} = {i}_{b}^{2} \cdot r \cdot R ( 1 - {e}^{- \frac{1}{c \cdot R} \cdot t} ) \qquad [ Equation 9 ]$$

Equation 9 is a mathematical expression for calculating the temperature rise ΔTn+2 of the wires 60a and 60b when the semiconductor switches SW3 and SW2 are ON. The temperature rise ΔTn+2 is the amount by which the wire temperature increases during the period in which the semiconductor switches SW3 and SW2 remain continuously ON. In addition, the time T is the period during which the semiconductor switches SW3 and SW2 remain continuously ON. In addition, in the above S130, the control circuit 30 calculates the temperature Tn+2 of the wires 60a and 60b by adding the temperature Tn+1 to the temperature rise ΔTn+2, as shown in Equation 10.

$${T}_{n + 2} = {T}_{n + 1} + Δ {T}_{n + 2} \qquad [ Equation 10 ]$$

Next, in S140, the control circuit 30 determines YES if the temperature Tn+2 of the wires 60a and 60b is equal to or greater than the threshold value, regarding that an overcurrent is flowing through the wires 60a and 60b. Accordingly, in S150, as the first stop control unit, the semiconductor switches SW1, SW2, SW3, and SW4 are turned OFF. As a result, it is possible to stop the flow of overcurrent between the positive electrode 10 and the negative electrode 11 via the wires 60a and 60b.

According to the embodiment described above, the vehicle motor control apparatus 1 includes wires 60a and 60b and a control circuit 30, in addition to the H-bridge circuit 50 equipped with semiconductor switches SW1, SW2, SW3, and SW4. The semiconductor switch SW1 is disposed between the positive electrode 10 of the DC power supply and the semiconductor switch SW2. The semiconductor switch SW2 is disposed between the semiconductor switch SW1 and the negative electrode 11. The semiconductor switch SW3 is disposed between the positive electrode 10 and the semiconductor switch SW4. The semiconductor switch SW4 is disposed between the semiconductor switch SW3 and the negative electrode 11.

The wires 60a and 60b are connected in series with the DC motor 2a between the common connection terminals 40 and 41. The common connection terminal 40 is a first common connection terminal to which the semiconductor switches SW1 and SW2 are commonly connected. The common connection terminal 41 is a second common connection terminal to which the semiconductor switches SW3 and SW4 are commonly connected. In S110, the control circuit 30 keeps the semiconductor switches SW1 and SW4 continuously turned on, while the semiconductor switches SW2 and SW3 are turned off. As a result, the current ia flows from the positive electrode 10 through the semiconductor switch SW1, the input/output terminal 51, the wire 60a, the DC motor 2a, the wire 60b, the input/output terminal 52, and the semiconductor switch SW4 to the negative electrode 11.

In S170, the control circuit 30 turns on the semiconductor switches SW2 and SW3, while keeping the semiconductor switches SW1 and SW4 turned off. As a result, the current ib flows from the positive electrode 10 through the semiconductor switch SW3, the input/output terminal 52, the wire 60b, the DC motor 2a, the wire 60a, the input/output terminal 51, and the semiconductor switch SW2 to the negative electrode 11. In S130, the control circuit 30 calculates the temperature rise amount ΔTa, which is the increase in temperature of the wires 60a and 60b caused by the control processing in S110, based on the current ia. In S130, the control circuit 30 calculates the temperature rise amount ΔTb, which is the increase in temperature of the wires 60a and 60b resulting from the execution of the control processing in S170, based on the current ib.

In S130, the control circuit 30 calculates the temperatures of the wires 60a and 60b, taking into account the temperature rise amount ΔTa and the temperature rise amount ΔTb. For example, in S130, the control circuit 30 calculates the temperatures of the wires 60a and 60b by adding the temperature rise amount ΔTa and the temperature rise amount ΔTb. Accordingly, it is possible to calculate the temperatures of the wires 60a and 60b by taking into account both the heat generation of the wires 60a and 60b during forward rotation of the DC motor 2a and the heat generation of the wires 60a and 60b during reverse rotation of the DC motor 2a. Therefore, it is possible to accurately calculate the temperatures of the wires 60a and 60b. According to the present embodiment configured as described above, the following effects (α) and (β) can be obtained.

(α) When the control circuit 30 receives a stop command for the DC motor 2a from the electronic control unit, the control circuit 30 turns off the semiconductor switches SW1, SW2, SW3, and SW4 in S190. As a result, it is possible to stop the flow of current between the positive electrode 10 and the negative electrode 11 through the DC motor 2a and the wires 60a and 60b. The control circuit 30 calculates the temperatures of the wires 60a and 60b in S130, taking into account the heat dissipation from the wires 60a and 60b to their surroundings at the time the control processing in S190 is executed. Accordingly, it is possible to calculate the temperatures of the wires 60a and 60b at the time of stopping the DC motor 2a with even greater accuracy.

(β) In S150, the control circuit 30 determines whether an overcurrent is flowing through the wires 60a and 60b by determining whether the temperatures of the wires 60a and 60b, calculated in the temperature calculation process of S130, are equal to or higher than a threshold value. In S150, when the control circuit 30 determines that an overcurrent is flowing through the wires 60a and 60b, it turns off the semiconductor switches SW1, SW2, SW3, and SW4 so as to stop the overcurrent from flowing through the wires 60a and 60b. Therefore, overcurrent protection for the wires 60a and 60b can be appropriately performed.

### Second Embodiment

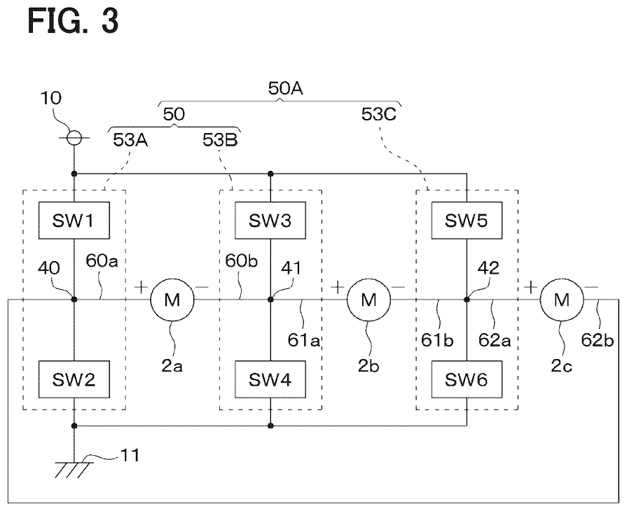

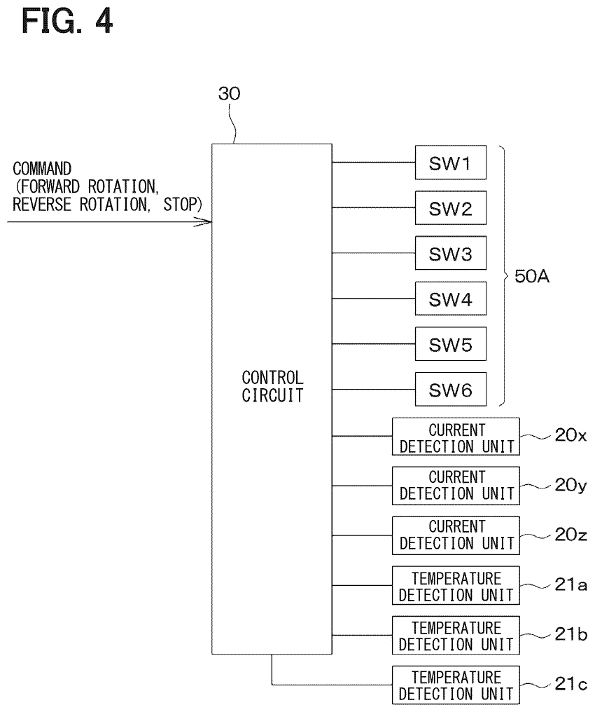

In the first embodiment described above, a vehicle motor control apparatus that controls a single DC motor 2a was explained. However, instead of this, the second embodiment of a vehicle motor control apparatus that controls DC motors 2a, 2b, and 2c will be described with reference to FIGS. 3 and 4. FIG. 3 is a diagram showing the electrical circuit configuration of the circuit 50A of the vehicle motor control apparatus according to the present embodiment. FIG. 4 is an electrical circuit diagram showing the connection relationships among the circuit 50A, the current detection units 20x, 20y, 20z, the temperature detection units 21a, 21b, 21c, and the control circuit 30 in the vehicle motor control apparatus.

As shown in FIG. 3, the vehicle motor control apparatus includes a circuit 50A in place of the H-bridge circuit 50, as well as the wires 60a, 60b, 61a, 61b, 62a, and 62b. The circuit 50A includes half-bridge circuits 53A, 53B, and 53C. As shown in FIG. 4, the vehicle motor control apparatus is provided with the current detection units 20x, 20y, 20z, the temperature detection units 21a, 21b, 21c, and the control circuit 30.

The half-bridge circuit 53A includes the semiconductor switches SW1 and SW2. The input terminal of the semiconductor switch SW1 is connected to the positive electrode 10. The output terminal of the semiconductor switch SW1 is connected to the input terminal of the semiconductor switch SW2. The output terminal of the semiconductor switch SW2 is connected to the negative electrode 11. The half-bridge circuit 53B, together with the half-bridge circuit 53A, constitutes the H-bridge circuit 50. The half-bridge circuit 53B includes the semiconductor switches SW3 and SW4. The input terminal of the semiconductor switch SW3 is connected to the positive electrode 10. The output terminal of the semiconductor switch SW3 is connected to the input terminal of the semiconductor switch SW4. The output terminal of the semiconductor switch SW4 is connected to the negative electrode 11.

The half-bridge circuit 53C includes semiconductor switches SW5 and SW6. The semiconductor switch SW5 is a fifth switch whose input terminal is connected to the positive electrode 10. The output terminal of the semiconductor switch SW5 is connected to the input terminal of the semiconductor switch SW6. The output terminal of the semiconductor switch SW6 (i.e., the sixth switch) is connected to the negative electrode 11. Hereinafter, for convenience of explanation, the terminal to which the semiconductor switches SW1 and SW2 are commonly connected will be referred to as the common connection terminal 40, and the terminal to which the semiconductor switches SW3 and SW4 are commonly connected will be referred to as the common connection terminal 41. The terminal to which the semiconductor switches SW5 and SW6 are commonly connected will be referred to as a common connection terminal 42.

Between the common connection terminals 40 and 41, wires 60a and 60b and the DC motor 2a are connected in series. The wire 60a is disposed between the common connection terminal 40 and the positive electrode of the DC motor 2a. A wire 60b is disposed between the negative electrode of the DC motor 2a and the common connection terminal 41. Between the common connection terminal 41 and the common connection terminal (i.e., the third common connection terminal) 42, the wires (i.e., second wires) 61a and 61b and the DC motor 2b are connected in series.

The wire 61a is disposed between the common connection terminal 41 and the positive electrode of the DC motor 2b. The wire 61b is disposed between the negative electrode of the DC motor 2b and the common connection terminal 42. Between the common connection terminals 42 and 40, the wires 62a and 62b and the DC motor 2c are connected in series. The wire 62a is disposed between the common connection terminal 42 and the positive electrode of the DC motor 2c. The wire 62b is disposed between the negative electrode of the DC motor 2c and the common connection terminal 40.

The current detection unit 20x is used to detect the current ix flowing through the wires 60a and 60b. As the current detection unit 20x of the present embodiment, for example, a detection element that detects the terminal voltage, which is the voltage between the input terminal and the output terminal of either one of the semiconductor switches SW1 or SW3, is used. The current ix is the current flowing through wires 60a and 60b between the common connection terminals 40 and 41.

The current detection unit 20y is used to detect the current iy flowing through the wires 61a and 61b. As the current detection unit 20y of the present embodiment, for example, a detection element that detects the terminal voltage, which is the voltage between the input terminal and the output terminal of either one of the semiconductor switches SW3 or SW5, is used. The current iy is the current flowing through wires 61a and 61b between the common connection terminals 41 and 42.

The current detection unit 20z is used to detect the current iz flowing through the wires 62a and 62b. As the current detection unit 20z of the present embodiment, for example, a detection element that detects the terminal voltage, which is the voltage between the input terminal and the output terminal of either one of the semiconductor switches SW5 or SW1, is used. The current iz is the current flowing through wires 62a and 62b between the common connection terminals 42 and 40. It should be noted that the current detection units 20x, 20y, and 20z are each configured with the same type of detection element as the current detection unit 20a in the first embodiment described above.

Furthermore, the temperature detection unit 21a is a temperature sensor that detects the ambient temperature of the wires 60a and 60b. The temperature detection unit 21b is a temperature sensor that detects the ambient temperature of wires 61a and 61b. The temperature detection unit 21c is a temperature sensor that detects the ambient temperature of wires 62a and 62b. The temperature detection units 21a, 21b, and 21c are each configured with the same type of temperature sensor as the temperature detection unit 21a in the first embodiment described above.

The control circuit 30 is a microcomputer equipped with a CPU, RAM, ROM, non-volatile rewritable memory, an analog-to-digital converter, and the like. The control circuit 30 executes a computer program recorded in a ROM or non-volatile rewritable memory, which are non-transitory tangible recording media, while power is being supplied from the power supply device. The control circuit 30 executes various control processes, such as the motor control process shown in FIG. 2, in accordance with the execution of the computer program.

The motor control process controls the DC motors 2a, 2b, and 2c, while also performing wire protection to prevent overcurrent from flowing through the wires 60a, 60b, 61a, 61b, 62a, and 62b based on the currents ix, iy, and iz. Various constants for calculating the temperatures of the wires 60a, 60b, 61a, 61b, 62a, and 62b are recorded in the ROM and the non-volatile rewritable memory, together with the computer program. The analog-to-digital converter converts the output voltages of the current detection units 20x, 20y, and 20z, as well as the output voltages of the temperature detection units 21a, 21b, and 21c, into digital signals, respectively.

Next, the operation of the vehicle motor control apparatus 1 of the present embodiment will be described with reference to FIG. 2. The control circuit 30 of the present embodiment repeatedly executes motor control processing for each DC motor in accordance with the flowchart shown in FIG. 2. First, the temperature detection unit 21a outputs to the control circuit 30 an output voltage indicating the ambient temperature of the wires 60a and 60b. The temperature detection unit 21b outputs to the control circuit 30 an output voltage indicating the ambient temperature of the wires 61a and 61b. The temperature detection unit 21c outputs to the control circuit 30 an output voltage indicating the ambient temperature of the wires 62a and 62b.

The current detection unit 20x outputs to the control circuit 30 an output voltage indicating the terminal voltage across semiconductor switch SW1 and an output voltage indicating the terminal voltage across semiconductor switch SW3. The current detection unit 20y outputs to the control circuit 30 an output voltage indicating the terminal voltage across semiconductor switch SW3 and an output voltage indicating the terminal voltage across semiconductor switch SW5. The current detection unit 20z outputs to the control circuit 30 an output voltage indicating the terminal voltage across semiconductor switch SW5 and an output voltage indicating the terminal voltage across semiconductor switch SW1.

The analog-to-digital converter of the control circuit 30 repeatedly converts the output voltages from each of the current detection units 20x, 20y, and 20z, as well as from each of the temperature detection units 21a, 21b, and 21c, into digital data. Hereinafter, for convenience of explanation, the digital data indicating the output voltage of the temperature detection unit 21a will be referred to as the first temperature data. The first temperature data is digital data indicating the ambient temperature around the wires 60a and 60b. The digital data indicating the output voltage of the temperature detection unit 21b is referred to as the second temperature data. The second temperature data is digital data indicating the ambient temperature around the wires 61a and 61b. The digital data indicating the output voltage of the temperature detection unit 21c is referred to as the third temperature data. The third temperature data is digital data indicating the ambient temperature around the wires 62a and 62b.

The digital data indicating the output voltage of the current detection unit 20x when the semiconductor switches SW1 and SW4 are turned on is referred to as the first forward rotation voltage data. The first forward rotation voltage data is digital data indicating the voltage between the terminals of the semiconductor switch SW1 during the forward rotation of the DC motor 2a. The digital data indicating the output voltage of the current detection unit 20y when the semiconductor switches SW3 and SW6 are turned on is referred to as the second forward rotation voltage data.

The second forward rotation voltage data is digital data indicating the voltage between the terminals of the semiconductor switch SW3 during the forward rotation of the DC motor 2b. The digital data indicating the output voltage of the current detection unit 20z when the semiconductor switches SW5 and SW2 are turned on is referred to as the third forward rotation voltage data. The third forward rotation voltage data is digital data indicating the voltage between the terminals of the semiconductor switch SW5 during the forward rotation of the DC motor 2c.

The digital data indicating the output voltage of the current detection unit 20x when the semiconductor switches SW3 and SW2 are turned on is referred to as the first reverse rotation voltage data. The first reverse rotation voltage data is digital data indicating the voltage between the terminals of the semiconductor switch SW3 during the reverse rotation of the DC motor 2a. The digital data indicating the output voltage of the current detection unit 20y when the semiconductor switches SW5 and SW4 are turned on is referred to as the second reverse rotation voltage data.

The second reverse rotation voltage data is digital data indicating the voltage between the terminals of semiconductor switch SW5 during the reverse rotation of the DC motor 2b. The digital data indicating the output voltage of the current detection unit 20z when the semiconductor switches SW1 and SW6 are turned on is referred to as the third reverse rotation voltage data. The third reverse rotation voltage data is digital data indicating the voltage between the terminals of the semiconductor switch SW1 during the reverse rotation of the DC motor 2c. First, the control circuit 30 executes motor control processing for the DC motor 2a. In this case, the control circuit 30 executes the control processing of S100 to S200 in the same manner as in the first embodiment described above.

At this time, in S110, the control circuit 30 keeps the semiconductor switches SW1 and SW4 continuously turned on, while the semiconductor switches SW2, SW3, SW5, and SW6 remain turned off. As a result, the current ix flows from the positive electrode 10 to the negative electrode 11 through the semiconductor switch SW1, wire 60a, DC motor 2a, wire 60b, and semiconductor switch SW4. In S120, the control circuit 30 calculates the current ix [A] based on the first forward rotation voltage data, in the same manner as the above-mentioned current ia. In S130, the control circuit 30 calculates the temperature of the wires 60a and 60b based on the current ix calculated in S120 and the first temperature data.

In S170, the control circuit 30 keeps the semiconductor switches SW2 and SW3 continuously turned on, while the semiconductor switches SW1, SW4, SW5, and SW6 remain turned off. As a result, the current ix flows from the positive electrode 10 to the negative electrode 11 through the semiconductor switch SW3, the wire 60b, the DC motor 2a, the wire 60a, and the semiconductor switch SW2. In S180, the control circuit 30 calculates the current ix [A] based on the first reverse rotation voltage data, in the same manner as the above-mentioned current ib. Furthermore, in S130, the control circuit 30 calculates the temperature of the wires 60a and 60b based on the current ix calculated in S180 and the first temperature data.

In S190, the control circuit 30 continues to keep the semiconductor switches SW1, SW2, SW3, SW4, SW5, and SW6 all turned off. Accordingly, the flow of current between the positive electrode 10 and the negative electrode 11 of the DC power supply through the DC motor 2a and wires 60a and 60b is stopped. Next, in S200, the control circuit 30 calculates the current i (for example, zero) flowing through the wires 60a and 60b in order to calculate the temperature of the wires 60a and 60b. Furthermore, in S130, the control circuit 30 calculates the temperature of the wires 60a and 60b based on the current i calculated in S200 and the first temperature data.

Therefore, the control circuit 30 determines whether an overcurrent is flowing through the wires 60a and 60b by determining whether the temperature of the wires 60a and 60b, calculated as described above, is equal to or higher than a threshold value. When the control circuit 30 determines YES, i.e., that an overcurrent is flowing through the wires 60a and 60b, the control circuit 30 turns off the semiconductor switches SW1, SW2, SW3, SW4, SW5, and SW6 to stop the overcurrent from flowing through the wires 60a and 60b.

The control circuit 30 executes motor control processing for the DC motor 2b. In this case, in S100, the control circuit 30 determines whether the control circuit 30 has received a forward rotation command for rotating the DC motor 2b in the forward direction from the electronic control unit. In S110, the control circuit 30, functioning as the fourth control unit, turns on the semiconductor switches SW3 and SW6 while keeping the semiconductor switches SW1, SW2, SW4, and SW5 turned off.

As a result, the current iy (i.e., a third current) flows from the positive electrode 10 through the semiconductor switch SW3, wire 61a, DC motor 2b, wire 61b, and semiconductor switch SW6 to the negative electrode 11. In S120, the control circuit 30, similarly to the above current ia, calculates the current iy [A] based on the second forward rotation voltage data. In S130, the control circuit 30 calculates the temperature of wires 61a and 61b based on the current iy calculated in S120 and the second temperature data.

In S170, the control circuit 30, functioning as the fifth control unit, keeps the semiconductor switches SW4 and SW5 continuously turned on while turning off the semiconductor switches SW1, SW2, SW3, and SW6. As a result, the current iy flows from the positive electrode 10 through the semiconductor switch SW5, wire 61b, DC motor 2b, wire 61a, and semiconductor switch SW4 to the negative electrode 11. In S180, the control circuit 30 calculates the current iy [A] based on the second reverse rotation voltage data, similarly to the above current ib. In S180, the control circuit 30 calculates the temperature of wires 61a and 61b based on the current iy calculated in S170 and the second temperature data.

In S190, the control circuit 30 turns off the semiconductor switches SW1, SW2, SW3, SW4, SW5, and SW6. In S200, the control circuit 30 calculates the current i (for example, zero) flowing through the wires 61a and 61b when the semiconductor switches SW1, SW2, SW3, SW4, SW5, and SW6 are turned off. Next, in S130, the temperature of the wires 61a and 61b is calculated based on the current i calculated in S200 and the second temperature data.

Accordingly, the control circuit 30 determines whether an overcurrent is flowing through the wires 62a and 62b by determining whether the temperature of wires 62a and 62b, calculated in this manner, is equal to or greater than a threshold value. When the control circuit 30 determines YES, that an overcurrent is flowing through the wires 62a and 62b, the control circuit 30 turns off the semiconductor switches SW1, SW2, SW3, SW4, SW5, and SW6 to stop the overcurrent from flowing through the wires 62a and 62b.

The control circuit 30 executes motor control processing for the DC motor 2c. In this case, in S100, the control circuit 30 determines whether the control circuit 30 has received a forward rotation command for rotating the DC motor 2c in the forward direction from the electronic control unit. In S110, the control circuit 30 turns on the semiconductor switches SW2 and SW5 while keeping the semiconductor switches SW1, SW3, SW4, and SW6 turned off.

As a result, the current Iz flows from the positive electrode 10 through the semiconductor switch SW5, wire 62a, DC motor 2c, wire 62b, and semiconductor switch SW2 to the negative electrode 11. In S120, the control circuit 30 calculates the current Iz [A] based on the third forward rotation voltage data, in the same manner as for the above-mentioned current Ia. In S130, the control circuit 30 calculates the temperatures of the wires 62a and 62b based on the current Iz calculated in S120 and the third temperature data.

The control circuit 30, in S170, keeps the semiconductor switches SW1 and SW6 turned on while turning off the semiconductor switches SW2, SW3, SW4, and SW5. As a result, the current Iz flows from the positive electrode 10 through the semiconductor switch SW1, wire 62b, DC motor 2c, wire 62a, and semiconductor switch SW6 to the negative electrode 11. In S180, the control circuit 30 calculates the current Iz [A] based on the third reverse rotation voltage data, in the same manner as for the above-mentioned current Ib.

In S130, the control circuit 30 calculates the temperatures of the wires 62a and 62b based on the current Iz calculated in S180 and the third temperature data. Additionally, in S190, the control circuit 30 turns off the semiconductor switches SW1, SW2, SW3, SW4, SW5, and SW6. In S200, the control circuit 30 calculates the current i (for example, zero) flowing through the wires 62a and 62b when the semiconductor switches SW1, SW2, SW3, SW4, SW5, and SW6 are turned off. Next, in S130, the temperatures of the wires 62a and 62b are calculated based on the current i calculated in S200 and the third temperature data.

Therefore, the control circuit 30 determines whether an overcurrent is flowing through the wires 62a and 62b by determining whether the temperatures of the wires 62a and 62b, calculated in this manner, are equal to or greater than a threshold value. When the control circuit 30 determines YES, that is, that an overcurrent is flowing through the wires 62a and 62b, the control circuit 30 turns off the semiconductor switches SW1, SW2, SW3, SW4, SW5, and SW6 to stop the overcurrent from flowing through the wires 62a and 62b.

According to the above-described embodiment, the control circuit 30 executes motor control processing for the DC motor 2a. In S110, the control circuit 30 turns off the semiconductor switches SW2, SW3, SW5, and SW6, and turns on the semiconductor switches SW1 and SW4. As a result, the current Ix flows from the positive electrode 10, through the semiconductor switch SW1, wire 60a, DC motor 2a (i.e., the first electrical load), wire 60b, and semiconductor switch SW4, to the negative electrode 11. In S120, the control circuit 30 detects the current Ix flowing through wires 60a and 60b. In S130, the control circuit 30 calculates the temperature rise ΔTa, which is the increase in temperature of wires 60a and 60b (i.e., the first wire) resulting from the execution of the control processing in S110, based on the current Ix. In S170, the control circuit 30 turns off the semiconductor switches SW1, SW4, SW5, and SW6, and turns on the semiconductor switches SW2 and SW3. As a result, the current Ix flows from the positive electrode 10, through semiconductor switch SW3, wire 60b, DC motor 2a, wire 60a, and semiconductor switch SW2, to the negative electrode 11. In S180, the control circuit 30 detects the current Ix flowing through the wires 60a and 60b.

In S130, the control circuit 30 calculates the temperature rise ΔTb, which is the increase in the temperatures of the wires 60a and 60b resulting from the execution of the control processing in S170, based on the current Ix. Accordingly, the control circuit 30, as a first wire temperature calculation unit, calculates the temperatures of the wires 60a and 60b by taking into account both the heat generation in wires 60a and 60b during forward rotation of the DC motor 2a and the heat generation in wires 60a and 60b during reverse rotation of the DC motor 2a. Therefore, it is possible to accurately calculate the temperatures of the wires 60a and 60b.

When the control circuit 30 receives a stop command for the DC motor 2a from the electronic control unit, the control circuit 30 turns off the semiconductor switches SW1, SW2, SW3, SW4, SW5, and SW6 in S190. As a result, it is possible to stop the current from flowing from the positive electrode 10 to the negative electrode 11 through the wire 60a, DC motor 2a, and wire 60b. In S130, the control circuit 30 calculates the temperatures of the wires 60a and 60b, taking into account the heat dissipation from the wires 60a and 60b to their surroundings at the time of executing the control processing in S190. Accordingly, it is possible to calculate the temperatures of the wires 60a and 60b at the time of stopping the DC motor 2a even more accurately.

The control circuit 30 executes motor control processing for the DC motor 2b. In S110, the control circuit 30 turns off the semiconductor switches SW1, SW2, SW4, and SW6, and turns on the semiconductor switches SW3 and SW6. As a result, the current Iy flows from the positive electrode 10 to the negative electrode 11 through the semiconductor switch SW3, wire 61a, DC motor 2b, wire 61b, and semiconductor switch SW6.

In S120, the control circuit 30 detects the current Iy flowing through the wires 61a and 61b. In S130, the control circuit 30, functioning as a third temperature rise calculation unit, calculates the temperature rise ΔTa based on the current Iy (i.e., the fourth current). The temperature rise ΔTa is the increase in the temperatures (i.e., the third temperature rise) of the wires 61a and 61b that occurs as a result of the control process executed in S110.

In S170, the control circuit 30 turns off the semiconductor switches SW1, SW2, SW3, and SW6, and turns on the semiconductor switches SW4 and SW5. As a result, the current Iy flows from the positive electrode 10, through the semiconductor switch SW5, wire 61b, DC motor 2b (i.e., the second electrical load), wire 61a, and semiconductor switch SW4, to the negative electrode 11. In S180, the control circuit 30 detects the current Iy flowing through the wires 61a and 61b.

In S130, the control circuit 30, functioning as a fourth rise calculation unit, calculates the temperature rise ΔTb based on the current Iy (i.e., the fifth current). The temperature rise ΔTb is the amount by which the temperatures of the wires 61a and 61b increase (i.e., the fourth temperature rise) as a result of the control processing executed in S170. Accordingly, the control circuit 30, functioning as a second wire temperature calculation unit, calculates the temperature of wires 61a and 61b by taking into account the heat generation of the wires 61a and 61b during the forward rotation of DC motor 2a and the heat generation of the wires 61a and 61b during the reverse rotation of DC motor 2b. Therefore, the temperatures of the wires 61a and 61b can be accurately calculated.

When the control circuit 30 receives a stop command for the DC motor 2b from the electronic control unit, the control circuit 30 functions as a sixth control unit and, in S190, turns off the semiconductor switches SW1, SW2, SW3, SW4, SW5, and SW6. As a result, it is possible to stop the flow of current from the positive electrode 10 to the negative electrode 11 via the DC motor 2b and wires 61a and 61b. In S130, the control circuit 30 calculates the temperatures of wires 61a and 61b, taking into account the heat dissipation from the wires 61a and 61b to their surroundings during the execution of the control process in S190. Accordingly, it is possible to calculate the temperatures of the wires 61a and 61b at the time of stopping the DC motor 2b even more accurately.

The control circuit 30 executes motor control processing for the DC motor 2c. In S110, the control circuit 30 turns off the semiconductor switches SW2, SW3, SW4, and SW5, and turns on the semiconductor switches SW5 and SW2. As a result, current Iz flows from the positive electrode 10, through the semiconductor switch SW5, wire 62a, DC motor 2c, wire 62b, and semiconductor switch SW2, to the negative electrode 11. In S120, the control circuit 30 detects the current Iz flowing through the wires 62a and 62b. In S130, the control circuit 30 calculates the temperature rise ΔTa, which is the amount of temperature increase of the wires 62a and 62b resulting from the control processing executed in S110, based on the current Iz.

In S170, the control circuit 30 turns off the semiconductor switches SW1, SW2, SW3, and SW6, and turns on the semiconductor switches SW1 and SW6. As a result, the current Iz flows from the positive electrode 10, through the semiconductor switch SW1, wire 62b, DC motor 2b, wire 62a, and semiconductor switch SW6, to the negative electrode 11. In S180, the control circuit 30 detects the current Iz flowing through the wires 62a and 62b.

In S130, the control circuit 30 calculates the temperature rise ΔTb, which is the amount of temperature increase of wires 62a and 62b resulting from the control processing executed in S170, based on the current Iz. Accordingly, it is possible to calculate the temperatures of the wires 62a and 62b taking into account the heat generation of the wires 62a and 62b during both the forward rotation and the reverse rotation of the DC motor 2c. Therefore, the temperatures of wires 62a and 62b can be accurately calculated.

When the control circuit 30 receives a stop command for the DC motor 2c from the electronic control unit, the control circuit 30 turns off the semiconductor switches SW1, SW2, SW3, SW4, SW5, and SW6 in S190. As a result, it is possible to stop the flow of current from the positive electrode 10 to the negative electrode 11 through the DC motor 2c and wires 62a and 62b. In S130, the control circuit 30 calculates the temperature of the wires 62a and 62b, taking into account heat dissipation from the wires 62a and 62b to their surroundings during the execution of the control process in S190. Accordingly, it is possible to calculate the temperature of the wires 62a and 62b at the time of stopping the DC motor 2c even more accurately.

In S140, the control circuit 30, acting as a first current determination unit and a second current determination unit for each DC motor, determines whether an overcurrent is flowing through the wires by determining, for each motor, whether the temperature of the wires is equal to or higher than a threshold value. Accordingly, when the control circuit 30, functioning as a first stop control unit and a second stop control unit, determines for each DC motor that an overcurrent is flowing through the wires, the control circuit 30 controls the semiconductor switches SW1, SW2, SW3, SW4, SW5, and SW6. As a result, it is possible to stop overcurrent from flowing through the wires 60a, 60b, 61a, 61b, 62a, and 62b for each DC motor. Accordingly, overcurrent protection for the wires 60a, 60b, 61a, 61b, 62a, and 62b can be appropriately performed for each DC motor.

### Other Embodiments

(1) In the first embodiment described above, an example was explained in which the DC motor 2a is used as an electric load. However, instead of this, a light source device such as a hot cathode tube or a cold cathode tube, or a single-phase AC motor may be used as the electric load. Similarly, in the above second embodiment as well, a light source device such as a hot cathode tube or a cold cathode tube, or a single-phase AC motor may be used as the electric load instead of the DC motors 2a, 2b, and 2c.

(2) In the first embodiment described above, an example was explained in which the voltage between the terminals of the semiconductor switch SW1 detected by the current detection unit 20a is divided by the on-resistance of the semiconductor switch SW1 to calculate the current ia flowing through wires 60a and 60b. However, instead of this, the following methods (a), (b), and (c) may be used.

(a) The current detection unit 20a detects the voltage between the input and output terminals of the semiconductor switch SW4. The control circuit 30 calculates the current ia by dividing the voltage between the terminals of the semiconductor switch SW4 by the on-resistance of the semiconductor switch SW4.

(b) A resistive element, which is a shunt resistor connected in series with the wires 60a and 60b between the positive electrode 10 and the negative electrode 11 and through which the current ia flows, is used as the current detection unit 20a. The current detection unit 20a calculates the terminal voltage, which is the voltage between one terminal and the other terminal of the resistive element, when the semiconductor switches SW1 and SW4 are turned on. The control circuit 30 calculates the current ia by dividing the terminal voltage of the resistive element by the resistance value of the resistive element.

(c) A transistor that forms a current mirror circuit together with the semiconductor switch SW1 is used as the current detection unit 20a. The control terminal of the transistor is connected to the control terminal of the semiconductor switch SW1. The input terminal of the transistor is connected to the positive electrode 10 of the DC power supply. The output terminal of the transistor is connected to the negative electrode 11. A detection current, which is a current proportional to the current ia, flows through the input and output terminals of the transistor. The control circuit 30 detects the detection current instead of the current ia. Alternatively, a transistor forming a current mirror circuit together with the semiconductor switch SW4 may be used as the current detection unit 20a. A detection current, which is proportional to the current ia, flows through the input and output terminals of the transistor.

(3) Also in the above-described second embodiment, the calculation of the current ix flowing through the wires 60a and 60b is not limited to the case where the current detection unit 20x detects the terminal voltage of the semiconductor switch SW1 and divides the terminal voltage by the on-resistance of the semiconductor switch SW1. The following methods (d), (e), and (f) may also be employed.

(d) The current detection unit 20x detects the terminal voltage of the semiconductor switch SW4. The control circuit 30 calculates the current ia by dividing the terminal voltage of the semiconductor switch SW4 by the on-resistance of the semiconductor switch SW4.

(e) A resistive element, which is a shunt resistor connected in series with the wires 60a and 60b between the positive electrode 10 and the negative electrode 11 and through which the current ix flows, is used as the current detection unit 20x. The current detection unit 20x calculates the terminal voltage, which is the voltage between one terminal and the other terminal of the resistive element, when the semiconductor switches SW1 and SW4 are turned on. The control circuit 30 calculates the current ix by dividing the terminal voltage of the resistive element by the resistance value of the resistive element.

(f) A transistor that forms a current mirror circuit together with the semiconductor switch SW1 is used as the current detection unit 20x. The control terminal of the transistor is connected to the control terminal of the semiconductor switch SW1. The input terminal of the transistor is connected to the positive electrode 10 of the DC power supply. The output terminal of the transistor is connected to the negative electrode 11. A detection current, which is a current proportional to the current ix, flows through the input and output terminals of the transistor. The control circuit 30 detects the detection current instead of the current ix.

Alternatively, a transistor that forms a current mirror circuit together with the semiconductor switch SW4 may be used as the current detection unit 20a. A detection current, which is a current proportional to the current ix, flows through the input terminal and output terminal of the transistor. Further, in the above second embodiment, the current iy flowing through the wires 61a and 61b may also be calculated in the same manner as in (d), (e), and (f) above. In the above second embodiment as well, the current iz flowing through the wires 62a and 62b may be calculated in the same manner as in (d), (e), and (f) above.

(4) In the first embodiment described above, an example was explained in which the terminal voltage of the semiconductor switch SW3, detected by the current detection unit 20b, was divided by the on-resistance of the semiconductor switch SW3 to calculate the current ib flowing through the wires 60a and 60b. However, instead of this, the following methods (g), (h), and (i) may be used.

(g) The current detection unit 20b detects the terminal voltage between the input terminal and output terminal of the semiconductor switch SW2. The control circuit 30 calculates the current ib by dividing the terminal voltage of the semiconductor switch SW2 by the on-resistance of the semiconductor switch SW2.

(h) A resistive element, which is a shunt resistor connected in series with the wires 60a and 60b between the positive electrode 10 and the negative electrode 11 and through which the current ib flows, is used as the current detection unit 20b. The current detection unit 20b detects the terminal voltage between one end terminal and the other end terminal of the resistive element when the semiconductor switches SW3 and SW2 are turned on. The control circuit 30 calculates the current ib by dividing the terminal voltage of the resistive element by the resistance value of the resistive element.

(i) A transistor that forms a current mirror circuit together with the semiconductor switch SW3 is used as the current detection unit 20b. The control terminal of the transistor is connected to the control terminal of the semiconductor switch SW3. The input terminal of the transistor is connected to the positive electrode 10 of the DC power supply. The output terminal of the transistor is connected to the negative electrode 11. A detection current, which is a current proportional to the current ib, flows through the input and output terminals of the transistor. The control circuit 30 detects the detection current instead of the current ib. Alternatively, a transistor that, together with the semiconductor switch SW2, constitutes a current mirror circuit may be used as the current detection unit 20b. A detection current, which is a current proportional to the current ib, flows through the input and output terminals of the transistor. The control circuit 30 detects the detection current instead of the current ib.

(5) In the above-described second embodiment, it is not limited to the case where the current ib flowing through the wires 61a and 61b is calculated by dividing the terminal voltage between the terminals of the semiconductor switch SW3 detected by the current detection unit 20x by the on-resistance of the semiconductor switch SW3; instead, the following methods (j), (k), and (l) may also be used.

(j) The current detection unit 20x detects the terminal voltage between the input terminal and the output terminal of the semiconductor switch SW2. The control circuit 30 calculates the current ix by dividing the terminal voltage of the semiconductor switch SW2 by the on-resistance of the semiconductor switch SW2.

(k) A resistive element, which is a shunt resistor connected in series with the wires 60a and 60b between the positive electrode 10 and the negative electrode 11 and through which the current ix flows, is used as the current detection unit 20x. The current detection unit 20x detects the terminal voltage between one terminal and the other terminal of the resistive element when the semiconductor switches SW3 and SW2 are turned on. The control circuit 30 calculates the current ix by dividing the terminal voltage across the resistive element by the resistance value of the resistive element.

(l) A transistor that forms a current mirror circuit together with the semiconductor switch SW3 is used as the current detection unit 20b. The control terminal of the transistor is connected to the control terminal of the semiconductor switch SW3. The input terminal of the transistor is connected to the positive electrode 10 of the DC power supply. The output terminal of the transistor is connected to the negative electrode 11. A detection current, which is a current proportional to the current ix, flows through the input and output terminals of the transistor.

The control circuit 30 detects the detection current instead of the current ix. Alternatively, a transistor that constitutes a current mirror circuit together with the semiconductor switch SW2 may be used as the current detection unit 20x. A detection current, which is a current proportional to the current ix, flows through the input and output terminals of the transistor. The control circuit 30 detects the detection current instead of the current ix. Further, in the above second embodiment as well, the current iy flowing through the wires 61a and 61b may be calculated in the same manner as described in (j), (k), and (l) above. In the above second embodiment as well, the current iz flowing through the wires 62a and 62b may be calculated in the same manner as described in (j), (k), and (l) above.

(4) In the first embodiment described above, an example was explained in which each of the semiconductor switches SW1, SW2, SW3, and SW4 is constituted by a single semiconductor switch element. However, instead of this, the semiconductor switches SW1, SW2, SW3, and SW4 may be semiconductor switches with a current detection function, incorporating a current detection unit 20a or the current detection unit 20b. Similarly, in the above second embodiment, the semiconductor switches SW1, SW2, SW3, SW4, SW5, and SW6 may be semiconductor switches with a current detection function, incorporating the current detection unit 20a or the current detection unit 20b.

(5) In the above second embodiment, an example was described in which three DC motors 2a, 2b, and 2c are controlled by the circuit 50A. However, instead of this, it is also possible to control two DC motors by means of the circuit 50A. Alternatively, it is also possible to control four or more DC motors by means of the circuit 50A.

(6) In the above first and second embodiments, examples were described in which the control device of the present disclosure was applied to an automobile. However, instead of this, the control device of the present disclosure may be applied to various types of industrial equipment other than automobiles.

(7) In the above first and second embodiments, examples were described in which the ambient temperatures of the wires 60a and 60b were calculated based on the detected value of the temperature detection unit 21a. However, instead of this, a predetermined temperature may be used as the ambient temperatures of the wires 60a and 60b. Similarly, in the above second embodiment, an example was described in which the ambient temperatures of the wires 61a and 61b were calculated based on the detected value of the temperature detection unit 21b. However, instead of this, a predetermined temperature may be used as the ambient temperatures of the wires 61a and 61b.

Alternatively, the detected value of the temperature detection unit 21a may be used as the ambient temperature of the wires 61a and 61b. In the above second embodiment, an example was described in which the ambient temperatures of the wires 62a and 62b were calculated based on the detected value of the temperature detection unit 21c. However, instead of this, a predetermined temperature may be used as the ambient temperatures of the wires 62a and 62b. Alternatively, the detected value of the temperature detection unit 21a may be used as the ambient temperatures of the wires 62a and 62b.

(8) In the above first and second embodiments, an example was described in which, in S200, the control circuit 30 calculates the current i by dividing the voltage across the terminals of the semiconductor switch SW1 by the on-resistance of the semiconductor switch SW1. However, the control circuit 30 may calculate the current i by dividing the voltage across the terminals of the semiconductor switch SW2 by the on-resistance of the semiconductor switch SW2.

The control circuit 30 may also calculate the current i by dividing the voltage across the terminals of the semiconductor switch SW3 by the on-resistance of the semiconductor switch SW3. The control circuit 30 may also calculate the current i by dividing the voltage across the terminals of the semiconductor switch SW4 by the on-resistance of the semiconductor switch SW4.

(9) In the above second embodiment, an example was described in which the vehicle motor control apparatus is configured using the half-bridge circuits 53A, 53B, and 53C. However, instead of this, the vehicle motor control apparatus may be configured using four or more half-bridge circuits.

(10) It should be noted that the present disclosure is not limited to the embodiments described above, and various modifications can be made as appropriate within the scope described in the claims. Furthermore, the above embodiments are not mutually exclusive, and may be appropriately combined with each other except in cases where such combinations are clearly impossible. In addition, in each of the above embodiments, it goes without saying that the elements constituting the embodiments are not necessarily essential, except in cases where they are expressly stated to be essential or are considered to be clearly essential in principle. Furthermore, in each of the above embodiments, when numerical values such as the number, value, quantity, or range of the constituent elements are mentioned, they are not limited to those specific numbers except in cases where it is expressly stated to be essential or it is clearly limited to a specific number in principle.

What is claimed is:

1. A control apparatus comprising:
an H-bridge circuit including
a high potential node having a predetermined potential,
a low potential node having a potential lower than the high potential node,
a first switch located between the high potential node and the low potential node,
a second switch located between the first switch and the low potential node,
a third switch located between the high potential node and the low potential node, and
a fourth switch located between the third switch and the low potential node;
a wire connected to an electrical load in series between a first common connection terminal and a second common connection terminal, the first common connection terminal being a terminal to which the first switch and the second switch are commonly connected, the second common connection terminal being a terminal to which the third switch and the fourth switch are commonly connected; and
a control circuit configured to
execute a first operation in which the first switch and the fourth switch are turned on to pass a first current from the high potential node to the low potential node through the first switch, the electrical load, and the fourth switch,
execute a second operation in which the second switch and the third switch are turned on to pass a second current from the high potential node to the low potential node through the third switch, the electrical load, and the second switch,
calculate a first temperature rise amount of the wire based on the first current, the first temperature rise amount corresponding to a temperature rise of the wire in conjunction with the first operation,
calculate a second temperature rise amount of the wire based on the second current, the second temperature rise amount corresponding to a temperature rise of the wire in conjunction with the second operation, and
calculate a temperature of the wire based on the first temperature rise amount and the second temperature rise amount.

2. The control apparatus according to claim 1, wherein
the control circuit is configured to calculate the temperature of the wire by adding the first temperature rise amount and the second temperature rise amount.

3. The control apparatus according to claim 1, wherein
the control circuit is configured to:
calculate the temperature of the wire based on the first temperature rise amount, on a condition that the control circuit executes the first operation; and
calculate the temperature of the wire based on the second temperature rise amount, on a condition that the control circuit executes the second operation.

4. The control apparatus according to claim 1, wherein
the control circuit is configured to:
execute a third operation in which the first switch, the second switch, the third switch, and the fourth switch are controlled to stop a current flowing from the high potential node to the low potential node through the electrical load and the wire; and
calculate the temperature of the wire based on thermal dissipation of the wire during an execution of the third operation.

5. The control apparatus according to claim 1, wherein
the control circuit is configured to:
determine whether an overcurrent flows through the wire by determining whether the calculated temperature of the wire is higher than or equal to a threshold value; and
control the first switch, the second switch, the third switch, and the fourth switch to stop the overcurrent from flowing through the wire, on a condition that the control circuit determines that the overcurrent flows through the wire.

6. The control apparatus according to claim 1, wherein
the wire is a first wire, and
the electrical load is a first electrical load, the control apparatus further comprising:
a half bridge circuit including
a fifth switch located between the high potential node and the low potential node, and
a sixth switch located between the fifth switch and the low potential node; and
a second wire connected to a second electrical load in series between the second common connection terminal and a third common connection terminal, the third common connection terminal being a terminal to which the fifth switch and the sixth switch are commonly connected, wherein
the control circuit is configured to:
execute a fourth operation in which the third switch and the sixth switch are turned on to pass a third current from the high potential node to the low potential node through the third switch, the second electrical load, and the sixth switch;
execute a fifth operation in which the fourth switch and the fifth switch are turned on to pass a fourth current from the high potential node to the low potential node through the fifth switch, the second electrical load, and the fourth switch;
calculate a third temperature rise amount of the second wire based on the third current, the third temperature rise amount corresponding to a temperature rise of the second wire in conjunction with the fourth operation;
calculate a fourth temperature rise amount of the second wire based on the fourth current, the fourth temperature rise amount corresponding to a temperature rise of the second wire in conjunction with the fifth operation; and
calculate a temperature of the second wire based on the third temperature rise amount and the fourth temperature rise amount.

7. The control apparatus according to claim 6, wherein
the control circuit is configured to:
execute a sixth operation in which the first switch, the second switch, the third switch, the fourth switch, the fifth switch, and the sixth switch are controlled to stop a current flowing from the high potential node to the low potential node through the second electrical load; and
calculate the temperature of the second wire based on heat dissipation of the second wire during an execution of the sixth operation.

8. The control apparatus according to claim 7, wherein
the control circuit is configured to:
determine whether an overcurrent flows through the second wire by determining whether the calculated temperature of the second wire is higher than or equal to a threshold value; and
control the first switch, the second switch, the third switch, the fourth switch, the fifth switch, and the sixth switch to stop the overcurrent from flowing to the second wire, on a condition that the control circuit determines that the overcurrent flows to the second wire.
